(19) United States
(12) Patent Application Publication
(10) Pub. No.: US 2010/0077350 A1
(43) Pub. Date: Mar. 25, 2010

(54) COMBINING ELEMENTS IN PRESENTATION OF CONTENT

(75) Inventors: Jesse Lim, Bellevue, WA (US); Jonathan Eric Gleasman, Seattle, WA (US); Melinda Knight, Bellevue, WA (US); Jeremy Scott Knudsen, Monroe, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/237,732

(22) Filed: Sep. 25, 2008

(51) Int. Cl. G06F 3/048

(52) U.S. Cl. 715/810

(57) ABSTRACT

Different aspects of a visual experience (e.g., a particular graphic and a particular color) may be separately selected, and then combined to create a theme. The theme may be applied to content, in order to provide a visual experience that is customized to a user's specifications. For example, a user may have an account with a web site. The web site may provide the user with controls that allow the user to select, separately, graphics and color (or some other aspects of the visual experience). The theme may be created based on the particular combination selected by the user. The created theme may be stored, or otherwise associated with, the user's account, so that the theme may be applied to content when the user visits a web site. Themes based on a combination of user selections may be applied to web content or any other type of content.

### BACKGROUND

Many user interfaces (UIs) can have their appearance customized by a user. Some web applications allow a user to specify a visual theme that governs the appearance of content delivered by the web application. For example, a user might have an account with a web-mail service, and that account could be associated with the user's choice of a visual theme. Thus, the underlying content to be served to the user (e.g., an inbox, a message, a composition screen, etc.) could be delivered along with visual elements that are based on a “theme” chosen by the user. For example, one user might choose a theme that provides a blue background, and another user might choose a theme that has a red background. Thus, in the web-mail example, an inbox could be presented against different color backgrounds. Other types of web applications (e.g., search engines, blogs, on-line music stores, etc.) might allow for similar theme selection.

UI customization generally offers the user certain discrete, tightly-bound combinations of choices. The user might choose a particular theme for a web application, where the choice of theme determines a specific combination of graphics and color—e.g., light blue flowers, dark red cars, etc. Thus, the content is provided based on the combination of graphics and color set by the theme, and the user is limited to those combinations of graphics and color that are offered.

Colors of certain UI elements can be automatically tinted, in some circumstances, according to a user's choice of theme. For example, the border (or “chrome”) that surrounds an application window in certain operating systems may be tinted, so that the specific elements that make up the border may be displayed in a user-chosen color. The tint is applied to the border surrounding the window, but does not affect the content within the window.

### SUMMARY

Content may be presented with a visual theme that may be chosen by a user. A theme may have a graphic and a color, and the user may choose the graphic and color separately. The chosen theme may be applied to the content displayed by a web application, such as a web-mail system, a search engine, music store, an on-line word processor, or any other type of application. Thus, when a user interacts with the web application, the server that provides content to the user may provide content with the user's chosen visual theme. While a web application is one possible use of a theme, a theme could also be used with any type of application, such as a standalone or client-side application.

A system that allows user-specified themes may present, to a user, a control panel that allows the user to choose graphics and colors separately. For example, the control panel could have one control that allows the user to select a graphic, and another control that allows the user to select a color. The chosen combination of color and graphic may be stored as a theme, and the theme could then be applied to the content to affect the visual appearance of the content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example user interface that may be used to select elements of a theme.

FIG. 2 is a flow diagram of an example process in which a theme may be selected and/or used.

FIG. 3 is a block diagram of an example mechanism that may be used to select a color.

FIG. 4 is a block diagram of various example ways in which a theme could be applied to content.

FIG. 5 is a block diagram of an example system that could be used to apply a theme to content, and to deliver the content to the user.

FIG. 6 is a block diagram of example components that may be used in connection with implementations of the subject matter described herein.

### DETAILED DESCRIPTION

Many types of software allow users to customize the experience of using the software. Some applications give users a choice of “skins”. Some applications give users a choice of toolbars to be displayed. Certain web sites allow a user to create an account, and let the user customize what he or she wants to appear on the welcome page when logging into the site (e.g., particular stock quotes, weather for a particular zip code, etc.). While customization may be allowed to some degree, in many cases the customization is from a fixed menu. For example, a media player or music web site might allow a user to apply a guitar theme to the web site, but the guitar theme may be based on specific graphics that come in a specific color. A user might want to combine aspects of different themes. For example, the user might like the theme's guitar graphics, but might want to apply a different color than the theme offers.

The subject matter described herein may be used to create a theme by combining different visual aspects, such as: color, graphics, and/or motion (or even non-visual aspects such as geographic location, the progression of time, randomness, holidays or special events, and/or changes in weather). A system that employs the subject matter herein might present to the user a UI that offers, for example, a choice of graphics and color. The user might select a particular graphic and a particular color. The chosen graphic and color could be combined to create a theme. This theme could be applied to content. For example, if the subject matter herein is used as part of a web-mail application, the theme created from the user's chosen combination could be applied to the user's inbox, message-composition screen, etc.

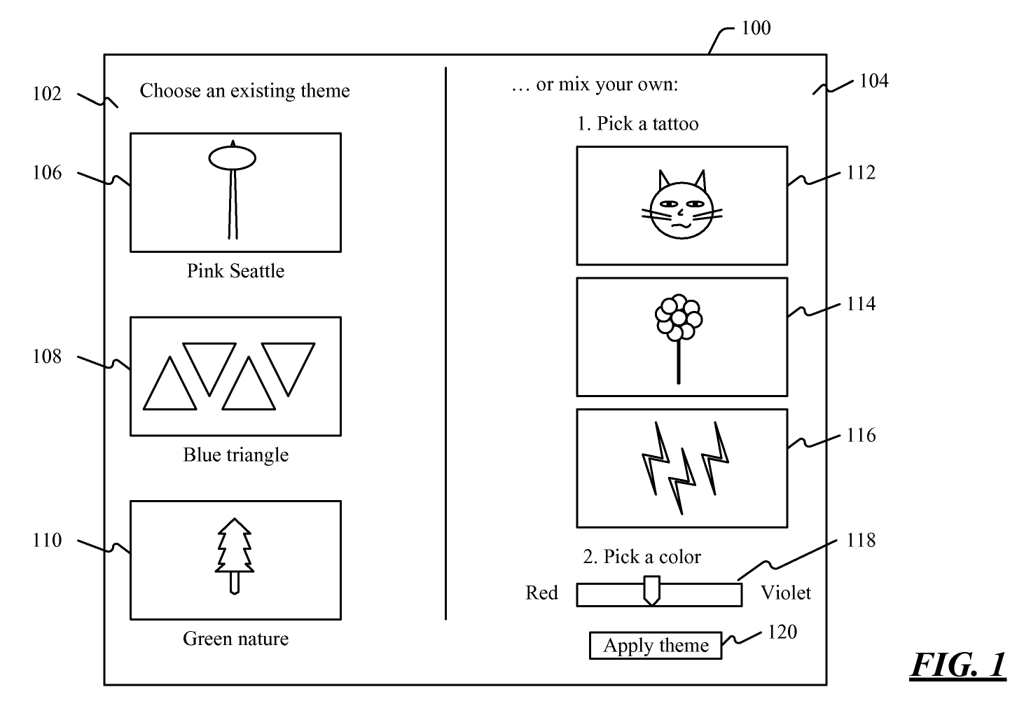

Turning now to the drawings, FIG. 1 shows an example user interface 100 that may be used to select elements of a theme. User interface 100 may provide spaces 102 and 104, which offer different options for selecting a theme. Space 102 offers the user a selection of existing themes, and space 104 offers the user the option to create a theme by combining a graphic and a color. Thus, space 102, in this example, offers the user three existing themes 106, 108, and 110, that represent a pre-selected combination of graphic and color. Theme 106 (named “Pink Seattle”) includes an iconic graphic of the City of Seattle, and has a pink tint. (The colors are not shown in the black-and-white line drawings, but the use of color will be understood from the textual description herein.) Similarly, theme 108 (named “Blue Triangles”) includes triangle graphics and is tinted blue, and theme 110 (named “Green Nature”) includes a graphic of a tree and is tinted green. If a user chooses from among themes 106-110, then the system that offers the theme selection could apply the chosen combination of graphics and color to content that it delivers to the user.

While the user might choose a theme from among themes 106-110, the user could also use space 104 to create a theme by separately selecting different elements. Thus, space 104 offers a choice of graphics 112, 114, and 116 (referred to, in this example, as “tattoos”), and also offers a mechanism 118 to choose a color. For example, a user might choose the cat image of graphic 112, the flower image of graphic 114, or the lightning bolt image of graphic 116. The user could then choose a color, using mechanism 118. In the example of FIG. 1, mechanism 118 is shown as a user-operable slider that offers a range of color values from red to violet, although any type of mechanism could be used. For example, mechanism 118 could take the form of a dial, a two-dimensional color plane, boxes into which to enter the numerical values of a color representation (such as RGB or YUV values), or any other mechanism. Moreover, while a single mechanism 118 is shown in FIG. 1, plural mechanisms could be used. For example, separate sliders could be offered to set hue, saturation, and luminance (brightness). In general, any mechanism or combination of mechanisms could be offered to set the color. Additionally, FIG. 1 shows an example in which a user selects a single color, but in general a user could select any number of colors to be part of a user-defined theme.

An “apply theme” button 120 could be provided by user interface 100. After the user chooses the various elements of the theme, such as a graphic and a color, the user could click button 120 in order to confirm the selection of those elements.

FIG. 1 shows an example in which the elements that may be selected separately are graphics and colors, although any types of elements could be selected separately. Moreover, in FIG. 1 there are two separate elements of a theme (graphic and color) that are separately selectable, although any number of different elements of a theme could be separately selectable. Additionally, while FIG. 1 shows an example in which user interface 100 offers both pre-defined themes and the ability to combine different elements into one theme, a user interface might offer one of these options but not the other. For example, a user interface to select themes could offer only pre-defined themes, or could offer only the option to create a theme from separate elements, or could offer a different way of choosing a theme.

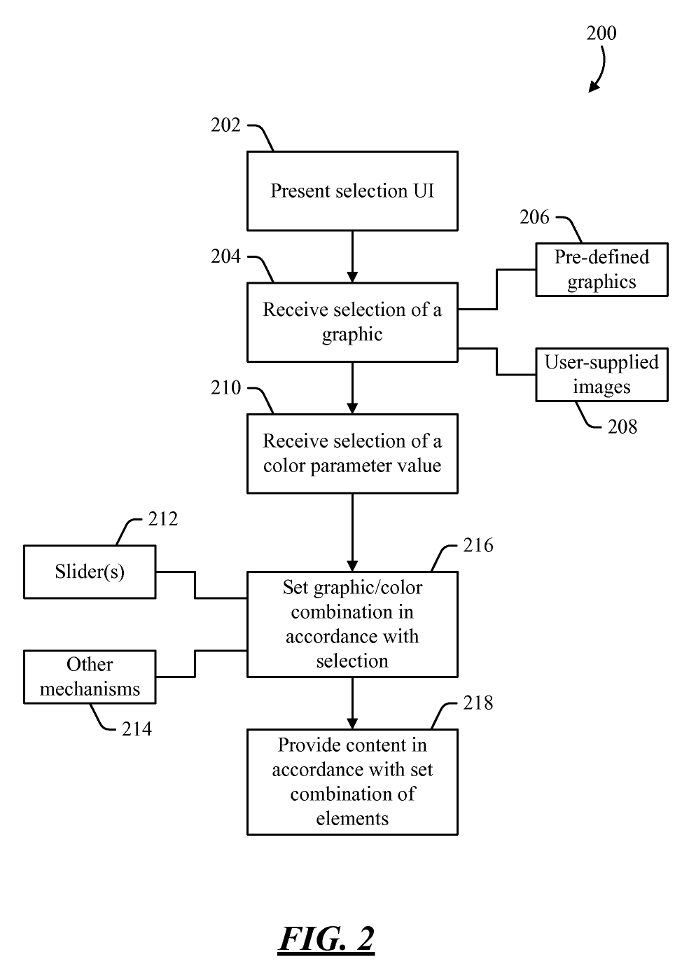

A system that allows customization of a user experience may present a user interface, such as that shown in FIG. 1, to a user. FIG. 2 shows an example process 200 that may be performed by such a system in order to allow for selection and/or use of such a theme. Before turning to a description of FIG. 2, it is noted that the process of FIG. 2 is described, by way of example, with reference to components and/or systems that are shown and described herein, although the process may be carried out in any system and is not limited to any particular system or component. Additionally, FIG. 2 shows an example in which stages of a process are carried out in a particular order, as indicated by the lines connecting the blocks, but the various stages shown in these diagrams could be performed in any order, or in any combination or sub-combination.

At 202, a selection UI may be presented to a user. For example, user interface 100 (shown in FIG. 1) could be the interface that is presented. In the example in which the user is selecting a theme for a web-based application, the UI could be presented as a web page, to be displayed through a web browser on a machine operated by the user. However, the subject matter described herein may be applied to any type of customizable use of a machine, regardless of whether that use is implemented in the form of a web site, a web application, a standalone application, a client-side application, etc.

At 204, a selection of a graphic may be received. For example, with reference to example user interface 100 (shown in FIG. 1), a user could click on a specific graphic (or “tattoo”) in order to select a graphic, although the selection could be made in any manner. The selected graphic may then become part of a theme. The graphic to be selected could come from various sources. For example, the software that presents the selection interface might maintain a set of pre-defined graphics 206, and the user's selection of a graphic could be made from among pre-defined graphics 206. As another example, the user (or some other entity) might supply a set of images 208, and such an image could be used as part of a theme. A user-supplied image could be analyzed to determine which portions of the image are to be tinted in the user's chosen color.

At 210, a selection of a value for a color parameter may be received. The selection could be received through a variety of mechanisms. For example, one or more slider(s) 212 (an example of which is shown by mechanism 118 in FIG. 1) could be used to receive a selection of a color parameter value. However other mechanisms 214 could be used in addition to, or in the alternative to, slider(s) 212. A value for a color parameter might constitute a complete description of a color. For example, the value received might represent a particular hue, with a particular amount of luminance. Or, a color parameter might be one component of a color, such that several components together define the color. For example, the value received might represent just the hue, but the actual color to be displayed could be based on the selected hue in the sense that some amount of luminance, saturation, etc., would be applied to the hue to create the color. Additionally, even after the color is set, the actual appearance could deviate from the setting based on time-of-day, weather, etc. For example, if the weather is dark or the time is at night, the actual color that is displayed could be darker than the user's selection, in order to allow the appearance of content reflect the current state of the natural world. Thus, at 210 a selection of a color parameter value may be received, but the relationship between the value received and the color to be displayed as part of the theme may take various forms.

At 216, a graphic and color combination is set in accordance with the selections that were received at 204 and 210. Thus, if a user selects a combination such as an image of a flower (e.g., graphic 114, shown in FIG. 1), and the color red, then the user's theme may be set to a red flower. Thus, red flowers could be provided as part of, or along with, content that is to be delivered to the user.

The stages shown and described at 204, 210, and 216 refer to an example in which the theme selected by the user is a combination of a color and a graphic. However the color and graphic are examples of two particular elements. In general, any type or number of elements could be combined to create a theme.

At 218, content may be provided in accordance with the theme represented by the chosen combination of elements. Thus, the content provided may, in some manner, be based on the theme or may incorporate elements of the theme. For example, if the content takes the form of pages provided by a web site, the pages may use the background color set by the theme. Or the content to be provided on the page (e.g., a web-mail inbox, an on-line music store, a search engine, a welcome page for a portal, etc.), may be adorned in some manner with the chosen graphic (which may or may not be tinted with the chosen color). There may be any amount or type of integration between the content and the color and/or graphic. For example, instances of the graphic could be integrated in individual icons. Thus, in such an example, if the graphic chosen for the theme is a flower and the chosen color is red, then envelope icons used in a web-mail application could be watermarked with instances of the flower, and/or the envelope could be tinted red. (Watermarking an image with a graphic is one example of how a graphic could be added to the image, although the graphic could be added in any manner.) As another example, the background of the page could be tinted in the chosen color, and the background could be watermarked with the chosen graphic. As further examples, a search box could be tinted in a user's chosen color, or selection highlighting could be done in a user's chosen color. The foregoing are some examples, although a particular graphic and/or color could be integrated with content in various ways. Additionally, when thematic elements other than color and graphic are used, these other elements could be integrated with content as well.

When content is provided in accordance with a user's chosen theme at 218, one example is to provide that content to the user. For example, the user's chosen theme might be used to affect the appearance of content displayed to that user on a web site. However, the user's chosen theme could be applied to content in other contexts. For example, the user's chosen theme might be applied to content created by, or belonging to, that user which is viewed by other users. Thus, a user might create a blog or a photo album and apply his or her chosen theme, and when other users view the blog or photo album they may see that theme. As a further example, the parameters of the user's chosen theme could be stored in a file, and the file could be stored for later user, or could be sent to other users as a way of sharing a theme.

As noted above, when content is provided, an aspect of user's chosen theme could be modified based on an external fact, such as the time of day or the weather. For example, the user might choose a particular shade of blue for the color, but a modification to the shade could be made such that the color would be darker at night or on rainy days. The modification could be used in applying the theme to the content.

As discussed above, when color is an element to be selected as part of a theme, the color could be selected in various ways. FIG. 1 shows an example in which a single control is used to select color on a single dimension. However, other mechanisms could be provided to select colors in different ways. FIG. 3 shows an example of another such mechanism 300.

Mechanism 300 comprises three sliders, 302, 304, and 306. Each slider represents a different component of a color's appearance. In the example of FIG. 3, slider 302 represents hue, slider 304 represents saturation, and slider 306 represents brightness. Any number of sliders could be used, and they could represent any aspect of a theme's appearance. For example, separate sliders might be used to represents luminance and chrominance components in a YUV color system, or red, green, and blue values in an RGB system. The sliders could affect aspects of appearance other than color, such as sharpness, distortion, etc. A slider is an example of a control that could be represented visually on a user interface, although any type of control (e.g., a dial, a text-entry box, etc.) could be used as part of mechanism 300.

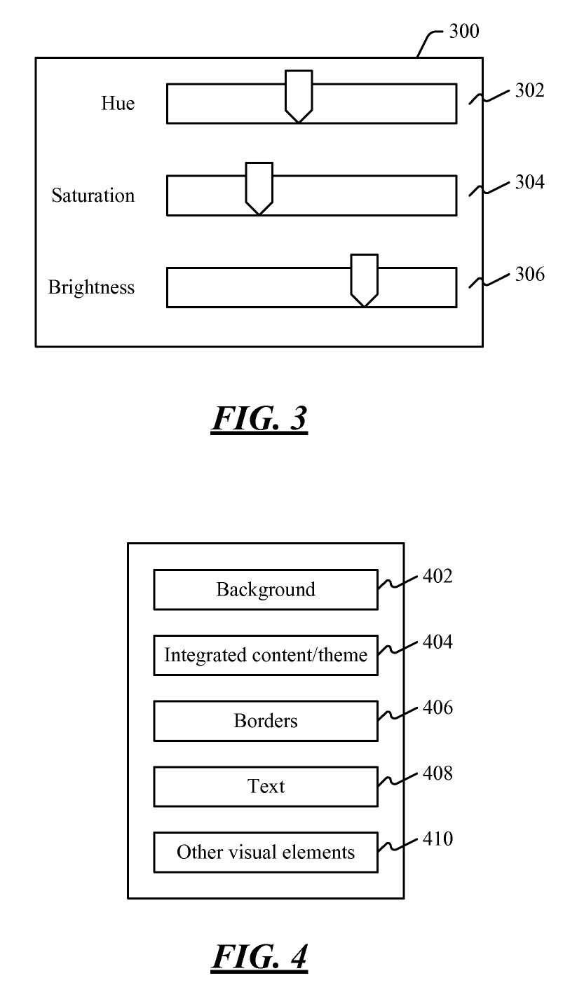

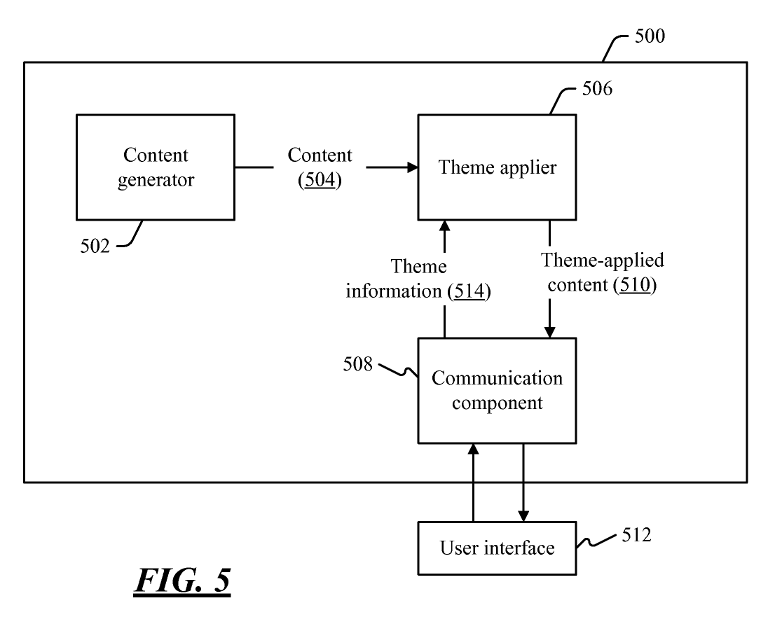

When a theme is selected, the theme may be applied to content in any manner. FIG. 4 shows examples of various ways in which a theme could be applied to content.

One way in which a theme could be applied to content is to affect the background of the content (block 402). For example, various types of content (e.g., a web-mail inbox, an on-line music store, a welcome page for a portal, a word-processing application, etc.) may be presented against a background. The background could be presented in a particular color, or could have a particular graphic. The graphic could be applied in various ways, such as by displaying the graphic in solid, opaque lines against a background, or by using the graphic to watermark the background at various levels of transparency. (The actual level of transparency could be pre-determined, or could be chosen by the user as one of the elements of the theme selection.)

Another way in which a theme could be applied to content is to integrate the theme into the content (block 404). For example, as previously described, the content may use certain types of images (e.g., an envelope icon for a mail application, an optical disc icon for an on-line music store, etc.), and the user's chosen color and/or graphic could be integrated into these images. For example, the images could be tinted with the user's chosen color, and/or the user's chosen graphic could be watermarked (or otherwise applied) to the images.

Another way in which a theme could be applied to content is to use the theme with the borders surrounding the content (block 406). For example, the borders could be tinted in a user's chosen color, and/or adorned with a user's chosen graphic.

Another way in which a theme could be applied to content is to apply the theme to text in the content (block 408). For example, the text could be displayed in a user's chosen color or colors. Moreover, other aspects of text could be chosen with a theme (e.g., a particular font).

The foregoing are some examples of ways in which a theme could be applied to content. However, other visual elements (block 410) could be affected by the user's chosen theme.

FIG. 5 shows an example system 500 that could be used to apply a theme to content, and to deliver the theme-applied content to the user. Content generator 502 generates some type of underlying content. The type of content that is generated depends on the particular function(s) that are being performed. For example, if mail-related functions are being performed, then the content might be an inbox, a composition screen, a set of contacts, etc. If the function being performed is word-processing, then the content might be a word processing screen with a composition area, and buttons or menus for selecting fonts, page, size, word spacing, etc. Any type of content could be generated by content generator 502. In FIG. 5, the content generated is labeled as content 504.

Content generator 502 provides content 504 to theme applier 506. Theme applier 506 applies a chosen them to content in some manner. Some example ways in which content could be applied are shown in FIG. 4 and are discussed above, although theme applier 506 could apply a theme to content 504 in any manner.

Theme applier 506 communicates with, or otherwise makes use of, a communication component 508. Theme applier 506 provides theme-applied content 510 (content to which a theme has been applied) to communication component 508. Communication component 508 then communicates the theme-applied content to a user interface 512. The delivery of theme-applied content 510 to user interface 512 could take any form. For example, if theme-applied content 510 is generated by a web application that runs on a server, then delivering theme applied content 510 to user interface 512 may involve sending theme-applied content 510 over the internet to a machine remote from the server (e.g., a user's desktop machine, wireless handheld computer, etc.), in order to be displayed on a browser. On the other hand, if theme-applied content is being generated by a standalone application that runs on a desktop computer (or laptop or handheld computer, or wireless telephone, etc.), then delivering content to user interface 512 may involve sending the content to a window (or other display element) on that machine.

It is noted that FIG. 5 shows an example in which user interface 512 is outside of system 500, which may be an appropriate model of the web-application scenario where system 500 comprises (or is part of) a server that delivers the content to a remote user machine. However, as the above examples demonstrate, interface 512 could be within system 500 (e.g., in the case where system 500 is a machine on which an application is running, and the user interface to which the application delivers content is a window displayed on that machine.)

In addition to displaying theme applied content 510, user interface 512 may also be used to receive a user's selection of a theme. For example, user interface 100 (shown in FIG. 1) may be (or may be part of) user interface 512. Thus, communication component 508 may be used to communicate information 514, concerning a user's choice of theme, back to theme applier 506. Information 514 may identify the user's choices (e.g., graphic, color, etc.) to theme applier 506, so theme applier 506 may use information 514 in order to learn of the user's choices and to apply those choices to content 504.

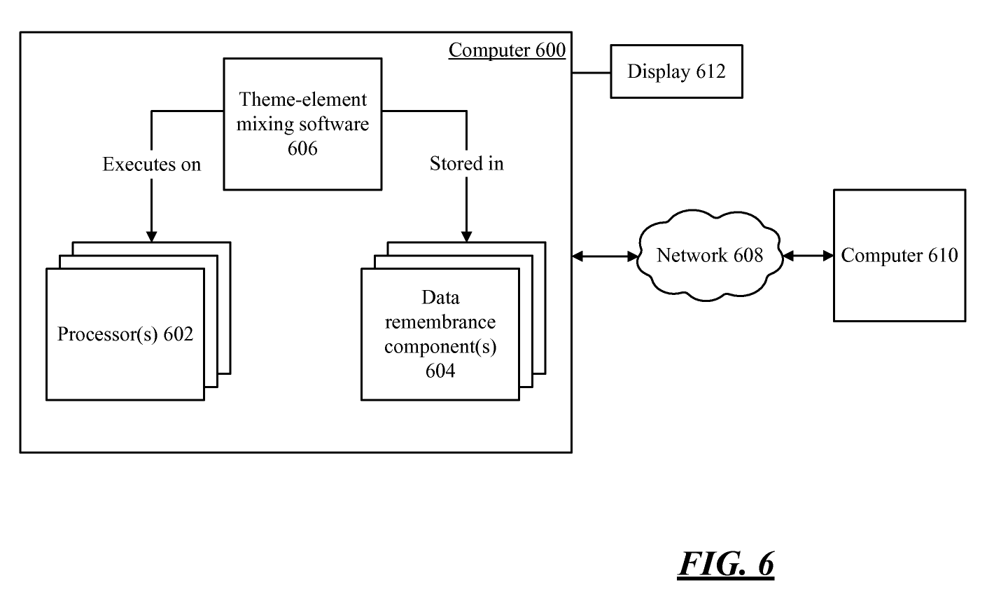

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is theme-element mixing software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as software having instructions to perform one or more acts of a method, where the instructions are stored on one or more computer-readable storage media. The instructions to perform the acts could be stored on one medium, or could be spread out across plural media, so that the instructions might appear collectively on the one or more computer-readable storage media, regardless of whether all of the instructions happen to be on the same medium.

In one example environment, computer 600 may be communicatively connected to one or more other devices through network 608. Computer 610, which may be similar in structure to computer 600, is an example of a device that can be connected to computer 600, although other types of devices may also be so connected.

It is noted that sometimes stages of a process in the appended claims are described with ordinal labels (e.g., “first receiving a color,” “second receiving a graphic”, etc.). The use of labels such as “first” and “second” is used to linguistically distinguish two uses of the same word (two uses of the word “receiving,” in the foregoing example), and does not imply that one stage is necessarily performed before the other.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to perform a method of controlling an appearance of content, the method comprising:
first receiving, from a user, a selection of a graphic;
second receiving, from said user, a selection of a first value of a first color parameter;
combining said graphic and said first color parameter, chosen by said user, to create a theme for said user; and
providing content to the user that is based on, or incorporates, said theme.

2. The one or more computer-readable storage media of claim 1, further comprising:
presenting, to said user, an interface that offers a selection of a plurality of graphics and a control that provides a way to select from among a range of values of said first color parameter, said graphic being among said plurality of graphics, and said first value being among said range of values.

3. The one or more computer-readable storage media of claim 1, wherein said second receiving comprises:
receiving the selection of said first value through a slider control that is operable by said user.

4. The one or more computer-readable storage media of claim 1, further comprising:
third receiving, from said user, a selection of a second value of a second color parameter, wherein a color is defined by a combination of a plurality of parameters that comprise said first color parameter and said second color parameter; and
combining said plurality of parameters to create said theme.

5. The one or more computer-readable storage media of claim 1, further comprising:
providing, to said user, a choice of a plurality of graphics, the selection of said graphic being made from among said plurality of graphics.

6. The one or more computer-readable storage media of claim 1, wherein said graphic is provided by said user, and wherein the method further comprises:
analyzing said graphic to determine which portions of said graphic are to be tinted with a color that is based on said first value.

7. A method of providing content, the method comprising:
providing, to a user, an interface that provides a choice of a plurality of graphics and a control that allows selection from among a range of colors;
receiving, from said user through the interface, a selection of a graphic from among said plurality of graphics;
receiving, from said user through the interface, a selection of a color from among said range of colors;
applying said graphic and said color to content, to create theme-applied content that incorporates said graphic and said color; and
providing said theme-applied content to said user.

8. The method of claim 7, wherein said applying comprises:
generating a web page that comprises at least some instances of said graphic, and that further comprises at least some images that are tinted with said color; and wherein said providing comprises:
delivering said web page to a browser on a machine operated by said user.

9. The method of claim 7, wherein said applying comprises:
creating a background that is tinted with said color.

10. The method of claim 7, wherein said applying comprises:
creating a background that incorporates said graphic.

11. The method of claim 7, wherein said content comprises an icon, and wherein said applying comprises:
adding said graphic to said icon.

12. The method of claim 7, wherein said content comprises an icon, and wherein said applying comprises:
tinting said icon in said color.

13. The method of claim 7, further comprising:
determining weather, or time of day, at a time when said theme-applied content is to be provided to said user; and
determining a modification to said color or to said graphic based on said weather or on said time of day;
and wherein said applying comprises:
creating said theme-applied content based on said modification.

14. A system to apply a theme, the system comprising:
one or more data remembrance components;
a content generator that generates content, said content generator comprising instructions that are stored in said one or more data remembrance components; and
a theme applier that receives theme information provided through a user interface, said theme information comprising a choice of color and a choice of graphic, said theme applier applying said color and said graphic to said content to create theme-applied content, said theme applier communicating said theme-applied content to said user interface to be displayed to said user.

15. The system of claim 14, further comprising:
a communication component through which said theme applier receives said theme information from said user interface and communicates said theme-applied content to said user interface.

16. The system of claim 14, wherein said user interface presents a control to said user through which said user selects said color from among a range of colors.

17. The system of claim 14, wherein said user interface presents a plurality of graphics to said user from among which said user selects said graphic.

18. The system of claim 14, wherein said theme information comprises a choice of a plurality of color components that together define said color.

19. The system of claim 18, wherein said plurality of color components comprise a hue component, a saturation component, and a brightness component.

20. The system of claim 14, wherein said theme applier determines an external fact and modifies said graphic or said color based on said external fact.
